(19) United States
(12) Patent Application Publication
(10) Pub. No.: US 2011/0289088 A1
(43) Pub. Date: Nov. 24, 2011

(54) SYSTEM AND METHOD FOR RANKING CONTENT INTEREST

(75) Inventors: Robert Myers Yarin, Agoura Hills, CA (US); David Salmela, Minneapolis, MN (US)

(73) Assignee: Frank N. Magid Associates, Inc., Marion, IA (US)

(21) Appl. No.: 13/109,184

(22) Filed: May 17, 2011

Related U.S. Application Data
(60) Provisional application No. 61/346,369, filed on May 19, 2010.

(51) Int. Cl. G06F 17/30

(52) U.S. Cl. 707/738; 707/E17.107

(57) ABSTRACT

A computer-implemented system and method for providing a ranking of content is disclosed. A computer processor is configured to access ranked listing content from one or more electronic sources. A database is connected to the processor and configured to store information related to the content. A software-implemented parsing module is configured to parse text of the content into individual words. A software-implemented counting module computes an appearance frequency for each word. A software-implemented ranking module associates a ranking with a parsed word. A software-implemented topic module identifies the content items in the snapshot containing a word and the associated rank of each such content item in the ranked listing in which it appears. A software-implemented content index module forms an index ranked list by computing an aggregate grouping score from the ranking. A display device is connected to the processor and configured to display the ranking associated with a word.

This application claims priority to U.S. Provisional Application No. 61/346,369, filed May 19, 2010, the content of which is hereby incorporated in its entirety by reference.

### TECHNICAL FIELD

The present application relates to computer implemented systems and methods for processing ranking data for content offerings. More particularly, the present application relates to systems and methods for computing and displaying aggregated data derived from data representing ranked lists of content interest from a plurality of media content sources, including internet sources.

### BACKGROUND

Content providing websites, such as those of news organizations, aggregators of news and other web content (e.g., Google) and the like, often display their content items, such as articles, video segments or other content units, in one or more ranked lists to users. Such rankings may pertain to, for example, the popularity of the content as indicated by the number of unique “views” a content item has received at a source site since publication (or within a defined time period), or the relevance of the content items to a particular topic or category. For example, the content providing website “CNN.com,” which is owned and operated by Turner Broadcasting System, Inc., displays a number of ranked lists to its viewers, including a “Latest News” list, a “Hot Topics” lists, a “Sports” list, a “Politics” list, among others.

Ranked listings provide a gauge to the relative importance of a particular content item to the viewing population, often based on the level of viewer interest (but potentially based on other ranking criteria, such as judgments by an expert panel). With more and more content outlets being available on the internet, television, radio, and other media channels, information pertaining to the relative interest of a particular topic or news story is particularly important to the editors and publishers of content-based media, as viewers will more likely choose to view media that provides the most relevant content.

Ranked listings from a single website, however, only provide an indication of the relative importance or popularity of a content item to the viewers of that single website, which may not be indicative of the content viewing population as a whole, or some segment of interest. For example, certain websites may be directed to viewers having particular interests, or political affiliations, or may be directed to only one category of content, such as business, sports, or politics. Further, where a website counts “views” of content it has aggregated as a basis for ranking, it can generally only count views processed through its website, not views initiated through the original publication website or another aggregation website, or views of another content item on the same topic but on another website. Thus, relying on a single ranked listing from a single website may not provide sufficient or accurate information regarding general interest in a particular topic discussed in multiple content items.

Computing and delivering aggregated content interest ranking data from a plurality of sites would provide information valuable to content sources who seek to serve their audiences better by providing content relevant to topics of interest.

### SUMMARY

It is therefore an object of the present application to provide up-to-date content rankings derived from a plurality of sources. In one embodiment, disclosed herein is a computer-implemented system for processing data representing ranked listings of content items, which may include: a computer processor configured to receive a snapshot associated with a point in time of data representing a ranked listing from each of two or more content sources, each listing ranking a plurality of content items; a database operably connected to the processor and configured to store for each ranked listing from each content source in a snapshot at least a text sample and the ordinal ranking of each content item in its ranked listing; a software-implemented topic grouping module configured to parse the text samples in a snapshot into keywords and responsive to keywords that the content items in a snapshot have in common, partitioning the content items in a snapshot into a plurality of topic grouping sets; a software-implemented topic scoring module configured to compute an index score for each topic grouping set from a snapshot by assigning to each content item in each topic grouping an individual rank score that represents that content item's ordinal ranking in the ranked listing in which it appears in the snapshot and, responsive to the individual rank scores, computing an aggregate topic grouping score for each topic grouping set from the individual rank scores for each content item in each topic grouping derived from a snapshot; a software-implemented content index ranking module configured to form an index ranked list by forming a ranked listing by aggregate topic grouping score for each topic grouping set in a snapshot; and a display device operably connected to the processor and configured to display the index ranked list.

While multiple embodiments are disclosed, still other embodiments of the present disclosure will become apparent to those skilled in the art from the following detailed description, which shows and describes illustrative embodiments. As will be realized, the invention is capable of modifications in various aspects, all without departing from the spirit and scope of the present disclosure. Accordingly, the drawings and detailed description are to be regarded as illustrative in nature and not restrictive.

### BRIEF DESCRIPTION OF THE FIGURES

While the specification concludes with claims particularly pointing out and distinctly claiming the subject matter that is regarded as forming the various embodiments of the present disclosure, it is believed that the embodiments will be better understood from the following description taken in conjunction with the accompanying Figures, in which:

FIG. 1 is an example computer-implemented system in accordance with one embodiment of the present disclosure.

FIG. 2 is a schematic database diagram showing accessing and storing of ranked listing data in accordance with one embodiment of the present disclosure.

FIG. 3 schematically describes an example parsing module for text samples from content items in accordance with one embodiment of the present disclosure.

FIG. 4 schematically describes an example content index ranking module in accordance with one embodiment of the present disclosure.

FIG. 5 is an example screenshot with a ranking display in accordance with one embodiment of the present disclosure.

FIG. 6 depicts the display of FIG. 5 with additional associated content information.

FIG. 7 is an example screenshot with a data display in accordance with one embodiment of the present disclosure.

FIG. 8 is an example screenshot showing index scores for three articles from a sequence of snapshots taken periodically over a 36-hour period.

FIG. 9 shows a schematic, functional block diagram according to one embodiment of the present disclosure.

### DETAILED DESCRIPTION

The present application relates to computer implemented systems and methods for processing and aggregating content item ranking data for content offerings. As will be described more fully below, the present application discloses a computer-implemented system configured to access data representing the ranked listings of content interest from a plurality of internet-based content providers. The system may then aggregate and/or combine these ranked listings using one or more user-configurable, computer-implemented algorithms to create and provide derivative content topic rankings based on a scoring index, as will be discussed in greater detail below. The aggregated rankings data with index scores provided by the system and method described herein may be used by media content publishers and/or editors, among others, to gain improved and/or specialized knowledge of content topics and categories which may be of interest or most relevant to media content viewers.

Such aggregated ranking data with index scores can be used to drive a variety of actions that permit a content provider (including an aggregator) to be more efficient, to better serve its audience, and to expand its audience. For example, the aggregated rankings data can be used to determine allocation of content provider resources. It may help determine what content items or stories to display in limited display space (such as a web page or front page) and their placement and/or determine rotation of displayed items or topics. It may also determine what stories receive writing, editorial, or investigative resources required to develop and produce a story. It may determine what content should be acquired and how long certain content should be featured. Thus, portions of the data output can be fed to a workflow system and/or displayed in various ways that aid decisions.

### Computer-Implemented System

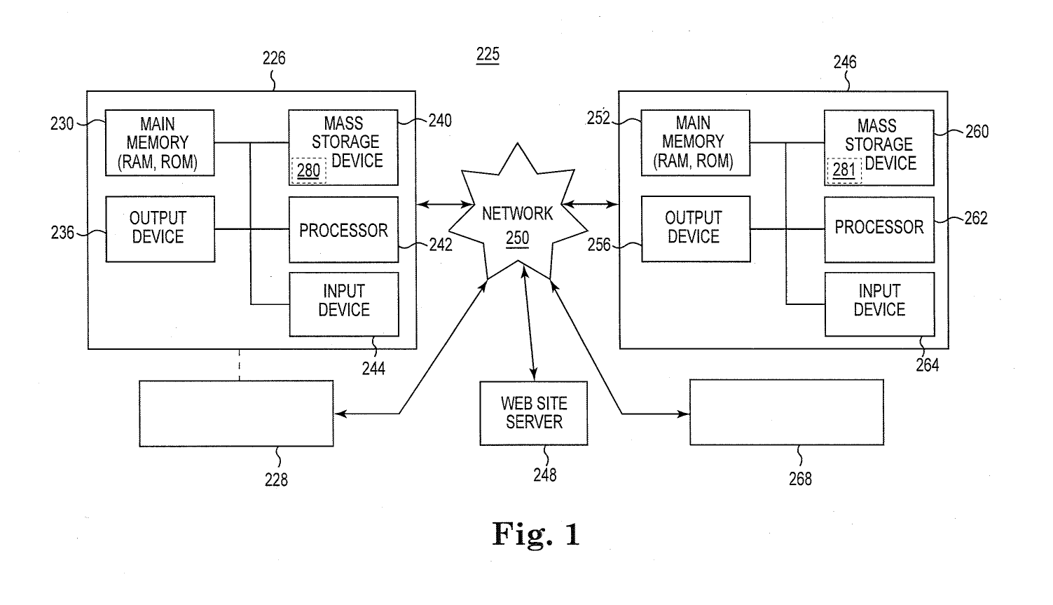

A ranking system and method in accordance with the present disclosure may be provided by computer-implemented means. FIG. 1 shows an example computing configuration suitable for use with the example ranked listing data processing system disclosed herein. Depicted in FIG. 1 is a diagram of an embodiment of a computing system 225 for implementing a ranking system and method. System 225 may include a computer access machine 226 connected with a network 250 such as the Internet. Individuals using computer access machine 226 can interact with a user interface server 246 in order to input and receive information, for example, including but not limited to, viewing and selecting content sources, which is described more fully below.

System 225 may also include the ability to access one or more web site servers 248 in order to obtain content from the Internet for use with the rankings described herein. While only one computer access machine 226 and one web site server 248 is shown for illustrative purposes, system 225 may include a plurality of access machines 226 and may be scalable to add or delete computer access machines to or from a network. It may also access many web site servers 248.

Computer access machine 226 illustrates typical components of an embodiment of a computer access machine. Computer access machine 226 may typically include a main memory 230, one or more mass storage devices 240, a processor 242, one or more input devices 244, and one or more output devices 236. Main memory 230 may include random access memory (RAM), read-only memory (ROM) or similar types of memory. One or more programs or applications 280, such as a web browser, and/or other applications used to perform the functions described herein may typically be stored in one more data storage devices 240. Programs or applications 280 used to perform the functions described may be loaded in part or in whole into main memory 230 and/or processor 242 during execution by processor 242. Mass storage device 240 may include, but is not limited to, a hard disk drive, floppy disk drive, CD-ROM drive, smart drive, flash drive or other types of non-volatile data storage, a plurality of storage devices, or any combination of storage devices. Processor 242 may execute applications or programs to run systems or methods of the present disclosure, or portions thereof, stored as executable programs or program code in memory 230 or mass storage device 240, or received from the Internet or other network 250. Input device 244 may include any device for entering information into machine 226, such as but not limited to, a microphone, digital camera, video recorder or camcorder, keyboard, mouse, cursor-control device, touch-tone telephone or touch-screen, a plurality of input devices, or any combination of input devices. Output device 236 may include any type of device for presenting information to a user, including but not limited to, a computer monitor or flat-screen display, a printer, and speakers, or any device for providing information in audio form, such as a telephone, a plurality of output devices, or any combination of output devices.

Applications 280, such as modules performing steps in a ranking method, or a web browser, may be used to access data in the ranking system and display the data in web pages, and allow information to be updated. Any commercial or freeware web browser or other application capable of retrieving content from a network and displaying pages or screens may be used to perform portions of the data processing functions described herein. In some embodiments, the customized applications 280 may be used to access, display, and update information for a user, as well as for the functional data processing required for aggregating ranking data.

Examples of computer access machines 226 for interacting with the ranking applications 280 and system include personal desktop computers, laptop computers, notebook computers, palm top computers, network computers, or any processor-controlled device capable of executing a web browser or other type of application for interacting with the system 225, including mobile devices such as cellular phones.

User interface server 246 may typically include a main memory 252, one or more mass storage devices 260, a processor 262, one or more input devices 264, and one or more output devices 256. Main memory 252 may include random access memory (RAM), read-only memory (ROM) or similar types of memory. One or more programs or applications 281, such as a web browser and/or other applications, may typically be stored in one or more mass storage devices 260. Programs or applications 281 may be loaded in part or in whole into main memory 252 and/or processor 262 for execution by processor 262. Mass storage device 260 may include, but is not limited to, a hard disk drive, floppy disk drive, CD-ROM drive, smart drive, flash drive or other types of non-volatile data storage, a plurality of storage devices, or any combination of storage devices. Processor 262 may execute applications or programs to run systems or methods of the present disclosure, or portions thereof, stored as executable programs or program code in memory 252 or mass storage device 260, or received from the Internet or other network 250. Input device 264 may include any device for entering information into server 246, such as but not limited to, a microphone, digital camera, video recorder or camcorder, keyboard, mouse, cursor-control device, touch-tone telephone or touch-screen, a plurality of input devices, or any combination of input devices. Output device 256 may include any type of device for presenting information to a user, including but not limited to, a computer monitor or flat-screen display, a printer, and speakers, or any device for providing information in audio form, such as a telephone, a plurality of output devices, or any combination of output devices.

Server 246 may maintain a database structure in mass storage device 260, for example, for storing and maintaining raw and processed ranking information and other data. Any type of data structure may be used, such as a relational database or an object-oriented database. In one embodiment, Microsoft SQL Server is used as the database management software, with stored data handling procedures. Server 246 may store applications 281 used to perform the various ranking functions described below.

When servers 226 and 246 are properly linked and can share data, either server may run the applications 280, 281 that provide the data access, data storage, data processing and data display functions that are described below. Processors 242, 262 may, alone or in combination, execute one or more applications 280, 281 in order to provide some or all of the functions, or portions thereof, of the ranking system and method described herein, and as will be discussed in greater detail below.

Users may monitor system performance, input data, modify parameters of the ranking system using output devices 236, 256 and input devices 244, 264 of server 226, 246, or may use one or more remote computer access machines 228, 268, which may communicate to server 246 directly, or via the network 250, for example.

As will be appreciated by those skilled in art, the present disclosure is not limited to systems such as shown in FIG. 1, but may also be implemented on other processing devices, such as personal computers, hand-held devices, wireless devices, and networked systems, among others, alone or in various combinations.

### Accessing Website Ranked Listings Data

The system and method disclosed develop a content performance index, with an index score for each of a plurality of topics addressed from time-to-time by content items. The index score for a topic represents an aggregate score for the content items on a topic that appear in multiple ranked listings found in a “snapshot” of listings associated with a point in time. Content items in a snapshot that address the same topic are scored together. The grouping of content items to be scored together is discussed below. Once content items are grouped by topic and scored based on their rank in the ranked listing where they appear, the aggregate score can be developed that shows the relative ranking of each topic grouping of content items and against other topic groupings represented in the same snapshot. To get the snapshot to start the index scoring process, the system of the present disclosure may electronically access the data representing ranked listings of one or more media content providing or aggregating websites or other electronic sources. For example, such websites include, but are not limited to, “Google News” (http://news.google.com), “Yahoo News” (http://news.yahoo.com), “Reuters” (http://www.reuters.com), “CNN Online” (http://www.cnn.com), “New York Times.com” (http://www.nytimes.com), and many others. Other electronic sources from which media content rankings data may be accessed include electronic mail (E-mail), text messaging, and wire services, among others.

While the ranked listings accessed for index scoring typically are based on viewer interest as measured by the number of views of a content item since publication or over a defined period, ranked listings with another ranking basis may be used. For example, the ranked listing may be based on a metric of how many times a content item has been sent by one viewer to another, or by some form of voting for a content item. The rankings also may be based on other criteria, such as ranking of a set of content items by an expert panel, or by a focus group or thought leader panel. The system may process any set of ranked listings into an aggregate, index score ranking, based on index scores derived for groupings of content items that may be found within ranked listings in a snapshot. Typically the groupings will be based on a common topic, subject or story that an audience is following, such as a news event, a country or city, a person, or a team. While the ranked listings of content items may be a top-five, a top-ten or top-twenty list, or a list of any length, for ease of the computations below, the listings used for an index preferably are all of the same length or may be truncated to the same length as part of processing.

Data representing ranked listings of content items and all or portions of the content itself may be electronically accessed for processing as disclosed herein by a variety of means. Such means may include, for example, Really Simple Syndication (“RSS”) data feeds. As is known to those of ordinary skill in the art, RSS feeds include a family of web feed formats used to publish frequently updated content—such as news headlines, audio, and video—in a standardized format. An RSS document (which may be alternately referred to herein as a “feed”, “web feed”, or “channel”) may include full or summarized text, plus metadata such as publishing dates and authorship. RSS feeds can be read using software called an “RSS reader”, “feed reader”, or “aggregator”, among other means, which can be web-based, desktop-based, or mobile-device-based. RSS formats may be specified using XML (Extensible Markup Language), a generic specification for the creation of data formats. The standardized XML file format allows the information to be published once and viewed by many different programs. An RSS feed may be accessed by, for example, “subscribing” to the feed by entering into the reader the feed's Uniform Resource Identifier (“URI”) or by clicking an RSS icon in a web browser that initiates the subscription process. The RSS reader may check the subscribed feeds at any specified interval for new work, download any updates that it finds, and provide an electronic interface or platform to monitor and read the feeds. Accessing RSS feeds may be performed automatically by the presently disclosed ranking system, or it may be done manually be a user. Preferably, the snapshots of ranked listings used as input data for processing are captured by periodic, automatic collecting of data accessible via RSS feeds.

Alternative means for accessing content rankings data include, for example, a technique commonly referred to by those skilled in the art as “scraping,” which includes accessing and parsing data of websites, for example, screen content in HyperText Markup Language (“HTML”) format, and thereafter saving portions of the parsed information (e.g., the screen content representing a ranked listing) in a database. Other accessing techniques for ranked listings data will be known by those of ordinary skill in the art, and are therefore intended to be within the scope of the present disclosure.

Particular website or other electronic ranked listings data may be selected to be accessed automatically by the system, or they may be selected by a user. In one embodiment, the system automatically accesses all of a defined set of the ranked listings, the addresses of which may be stored in a database of websites or other electronic sources. Such accessing may occur at regular intervals, for example hourly, every 2, 4 or 6 hours, daily, or weekly. The data accessed at a point in time (which may actually be over a period of minutes as required by the accessing equipment used and availability of the content source where the ranked listing is accessed) may be called a snapshot. The ranked listings of content items in snapshot may be associated with a point in time, which may represent a time period over which the ranking data was accumulated (there being no truly instantaneous view of the level of interest as measured by views, as views occur over time). In an alternative embodiment, for a snapshot only a user-specified subset of the defined set of ranked listings available to the system may be accessed, for example, only the websites pertaining to a particularly specified category (sports content rankings, business content rankings, regional content rankings, etc.), or only the websites as may be individually specified by a user.

In one embodiment, accessing the ranked listings may include receiving a snapshot of data representing a ranked listing (ranking a plurality of content items) from one or more content sources, for example RSS feeds, at a point in time. This snapshot of ranked listing data may include any text or metadata of, comprising or pertaining to the ranked content accessed, for example, a content item (article, video segment, photo) identification number, a content headline, a content summary, keywords, a URL link to the content item if the content is Internet-based, a date of the content, and a globally unique identifier (GUID) of the content item which may be assigned by the RSS feed sorter. Other like data may be similarly retrieved. This content information and data retrieved in a particular snapshot of multiple ranked listings may be saved into one or more tables of a database.

In some embodiments, information concerning a particular snapshot may also be saved in addition to the ranked listings of content items comprising the snapshot. Such snapshot data may include a unique snapshot identification number, a snapshot creation date, and a snapshot completion date. This snapshot data may be saved into one or more tables of a database.

An additional database table may be created by the system, including data concerning both the content items and the snapshot from which the content items were retrieved. Thus, a particular content item, and its associated ranking, may be correlated with a particular snapshot. This content/snapshot table may include the snapshot identification number, the content identification number, the ranking of the contents from the particular feed, and a date and/or time of the data in this table.

The aforementioned data comprising content, snapshot, and content/snapshot tables may be stored in one or more databases operably connected to the processor. In this manner, the processor may direct the system either automatically or on user command to receive ranked listing data from a content source as described above, and to store such content related data in the one or more tables of the one more databases described.

Depicted in Table 1 below is a highly simplified example of a table containing ranked listing data that may be stored in a database of the content ranking system from one snapshot. Table 1 depicts partial ranked listings (labeled 1^{st}, 2nd, 3^{rd}, 4^{th}, . . . ) from content sources 1 through N, with the sources' ranked content items identified by a headline. For example, associated with Source1 are the ranked headlines, “1. Obama Healthcare,” “2. Tiger Woods in Crash,” and “3. Bomb in Baghdad,” wherein the numerals represent the ordinal ranking of each content item identified by its headline. Content from Source2 and other sources is similar depicted. For simplicity, Table 1 shows each ranked listing example as identifying only three content items; typical actual ranked listings from a source rank ten or more content items but also may rank more or less than ten.

TABLE 1

| Source 1 | Source 2 | Source 3 | Source N |
|---|---|---|---|
| 1. Obama | 1. Obama Bill | 1. Unrest in | 1. Washington |
| Healthcare | Trouble | Lahore | Healthcare Jam |
| 2. Tiger Woods in | 2. Riot in | 2. Obama Health | 2. Baghdad |
| Crash | Lahore | Bill | Struck Again |
| 3. Bomb in | 3. Tiger Gets | 3. Tiger Out for | 3. Obama vs. |
| Baghdad | Bruises | Week | Insurers |
| 4., 5., . . . | 4., 5., . . . | 4., 5., . . . | 4., 5., . . . |

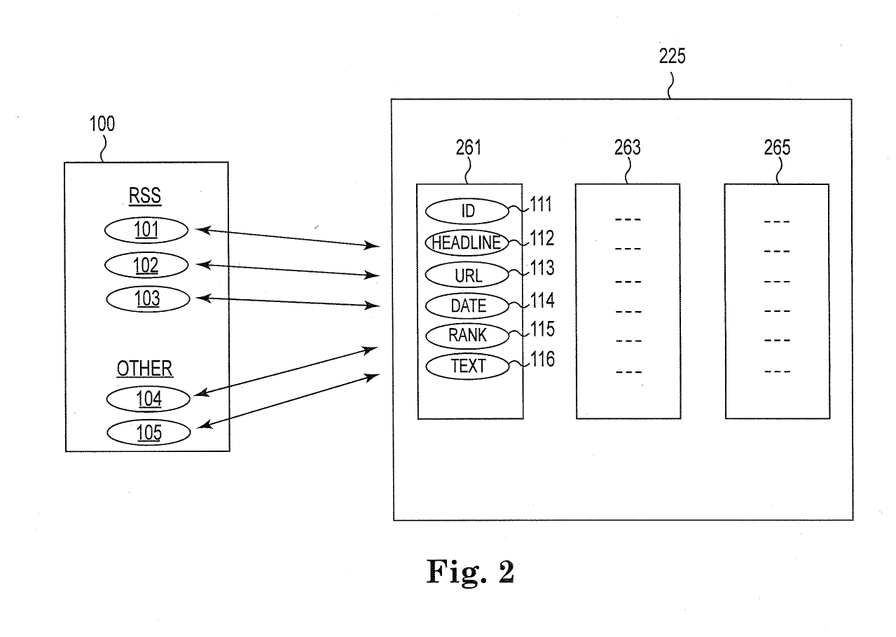

The functions of an access module accessing ranked listings of content are represented schematically in FIG. 2, wherein in a simplified example a plurality of content sources 100 with ranked listing data are accessed by the system 225. Sources include RSS feeds 101, 102, and 103, and other electronic sources for delivering ranked listings (which may include E-mail, wire service, etc., as discussed above) 104 and 105. System 225 may use the access module to retrieve the snapshots of content ranked listing data from RSS feeds 101-103 and other sources 104-105. The retrieved data may be stored in storage device 260 within system 225. Storage device 260 may be segregated into one or more databases 261, 263, 265 and/or one or more files, folders, tables or objects in a single database or multiple databases.

Content data and ranked listing data may be stored separately within the databases 261, 263, 265. For example, with regard to each content item found in a ranked listing from an electronic content data source in a snapshot, a variety of data fields may be stored. In one embodiment, the system may store within the one or more databases, files, etc. (depicted in database 261) a unique identification 111 associated with a content item, the headline 112 of the content item (e.g., the headline of a news article), the Uniform Resource Locator (“URL”) 113 associated with a content item, the date and time information 114 associated with each content item, the ranking 115 of each content item from the ranked listing where it has been found, and the text or content 116 of each content item in XML or HTML format, for example. Other information included in or concerning a content item, such as additional metadata, may be similarly stored within the databases 261, 263, 265.

### Processing of Ranked Content

One issue in the of aggregation of ranked listings is what set of content items should be brought together and counted, for purposes of content performance ranking and determining an index score, as part of a single topic or single “story”, which may mean recent developments on a broader topic that attract viewer/reader attention for period of time. For example, the current healthcare debate might be viewed as one topic or story or it might be broken into three topics, such as President Obama's efforts to get legislation passed, opposition-party actions to stop or modify a particular bill and the reaction of some lobbying group to a bill. If two or three related topics of separate interest emerge for separate ranking, they may later merge back into one broader topic. Thus, a system that looks at many content items needs the ability to group the items in many ways. Usually this means defining a grouping by some inclusion criteria, but a grouping developed at one point in time may later be split by redefining inclusion criteria. This partitioning or grouping of content items depends on a well-defined topic (or story) definition and is both subtle and seemingly somewhat arbitrary. However, for data processing, there must be a definite set of inclusion criteria that permits topic grouping of the content items within a snapshot.

One aspect of the grouping analysis is the question of what part of a content item is used as the basis for a topic characterization or for applying the topic inclusion criteria. The entire content item may be analyzed to identify the topic, using more or less sophisticated semantic analysis. Depending on the length of the content item, in most instances, it is more efficient to use a text sample taken from the content item. In the embodiment described below, the text sample is a headline. An initial sentence or paragraph may also be used as the text sample for determining the topic of a content item. The present method may be used with any text sample, including the entire text of the content item or metadata associated with a content item.

Ranked listing data from the plurality of individual content sources providing ranking data in a snapshot may be processed to identify topics by topic inclusion criteria, which may include combination and/or aggregation of criteria, according to one or more algorithms. Initial processing of the text sample may be accomplished by a parsing module of the content ranking system disclosed herein. The parsing module, in one embodiment, may be configured to parse the headline, for example, or other text sample of a content item stored within the databases. As will be appreciated by those skilled in the art, parsing may include separating and individually storing each word of a multiword headline. These individual words parsed from the content headlines for all content items in a snapshot may be saved within the system as a snapshot word list. In some embodiments, such a snapshot word list may be filtered to remove common words that generally do not have topic identifier value, known in the art as “junk words,” such as “and,” “the,” “is,” “to,” etc., and other words which do not contribute significant topical meaning to the headline where they appear. These words will not be useful for topic inclusion criteria. In other parsing, root words might be substituted for variants (e.g., “bill” and “bills” may be considered the same and be two instances of “bill”; “crash” and “crashed” would become two instances of “crash”; by contrast “wood” and “woods” might need to be kept separate, if the former meant a building material and the latter a surname). Some more sophisticated tools for preprocessing or parsing text may be used, such as, those discussed or referenced in US Publication 2007/0010993 A1, which is incorporated by reference.)

The snapshot word lists derived from text samples in a snapshot may be stored in the form of one or more tables within the databases 261, 263, 265. Shown below as Table 2 is a simplified example of a snapshot word list and a junk-word filtered snapshot word list. The words listed in Table 2 correspond to the unique words found in the headlines of content items ranked and listed in the snapshot of Table 1. (For simplicity, Table 2 does not list all unique words from the headlines in Table 1, but in a real snapshot word list analysis, all words in the text samples from a snapshot are analyzed in a first round. As can be seen in Table 2, the words Obama, Healthcare, Tiger, Woods, In, Crash, Bomb, Baghdad, Bill, Trouble, Riot, and Lahore appearing in the headlines of Table 1 have been individually listed in the first column of the simplified snapshot word list. Adjacent to the snapshot word list in Table 2, in the second column is depicted a filtered snapshot word list, which removes the junk word “In” (represented by strike-through).

TABLE 2

| snapshot word list | filtered snapshot word list |
|---|---|
| Obama | Obama |
| Healthcare | Healthcare |
| Tiger | Tiger |
| Woods | Woods |
| In | [symbol] |
| Crash | Crash |
| Bomb | Bomb |
| Baghdad | Baghdad |
| Bill | Bill |
| Trouble | Trouble |
| Riot | Riot |
| Lahore | Lahore |
| Etc. | |

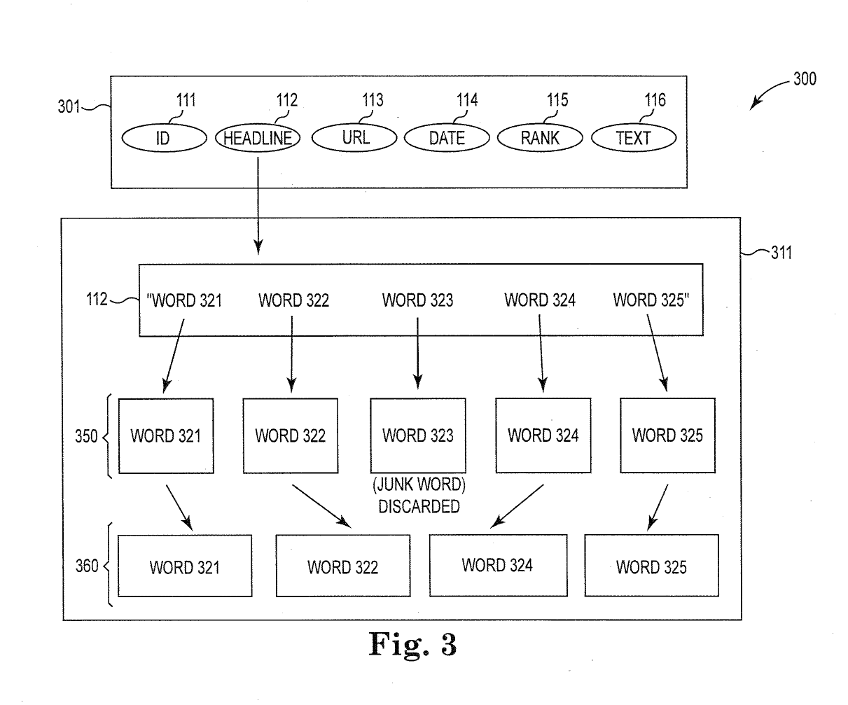

As depicted in FIG. 3, parsing module 300 with a parsing algorithm operates on a stored content item 301 having a unique identifier 111, a headline 112, a URL 113, a date and time 114, a rank 115, and text in XML format 116. Headline 112 may be parsed in parsing sub-module 311 at step 350, wherein words 321-325 are identified and separated. Junk words (shown as word 323) may be discarded at step 360. Thus, each unique word of the headline of a content item may be separated, and associated individually with the unique identifier, URL, date and time, rank, and text of the content item from which such word was derived.

In further embodiments, all or a portion of the text of the content stored in the content databases as retrieved from one or more snapshots may be parsed instead of or in addition to the headline of such content item. This additional text data may help identify the content item topic to permit it to be joined with or kept separate from other content items in its snapshot. Parsing may be performed similarly to that described above with respect to the headline (individually listing each word of the text), or parsing may be performed by software specially designed to process and filter large amounts of text, such as, for example, Open Calais. With a tool such as Open Calais, metadata may be derived and can provide additional keywords or other tags that help topic grouping. The derived metadata may become part of the text sample for a content item.

After the parsing module processes the ranked listing data of a snapshot into filtered snapshot word lists, based on a text sample, such as the content headline or the content text, development of topic inclusion criteria can proceed. In one embodiment a counting module 400 of the content ranking system disclosed herein may compute an appearance frequency for each word in the snapshot word list derived from all of the headlines and/or text samples of content items included in the snapshot, based on the number of times each word appears in the headlines or text. This word appearance frequency data may be saved within the system as one or more tables within the databases. Depicted below as Table 3 is an example word frequency table as might be implemented and created by the counting module for the filtered snapshot word list shown in Table 2. In this table, the word “Obama” is shown with an appearance frequency of 4, the word “healthcare” is shown with an appearance frequency of 2, the word “Tiger” is shown with an appearance frequency of 3, and so forth.

TABLE 3

| filtered snapshot word list | Appearances |
|---|---|
| Obama | 4 |
| Healthcare | 2 |
| Tiger | 3 |
| Woods | 1 |
| Crash | 1 |
| Bomb | 1 |
| Baghdad | 2 |
| Bill | 1 |
| Trouble | 1 |
| Riot | 1 |
| Lahore | 2 |
| etc. | |

Once the appearance frequency of the parsed words from either the content headline or the content text sample have been listed, a ranking module 400 of the content ranking system disclosed herein may form a ranked list by appearance frequency of each word in the filtered snapshot word list. As depicted in Table 4 below, the filtered snapshot word list has been ranked by the ranking module in descending order of appearance frequency of each respective word parsed from the content item headline of the accessed and retrieved content snapshot. As depicted, “Obama” is the highest ranked word with 4 appearances, “Tiger” is ranked second highest with 3 appearances, and “healthcare,” “Baghdad,” and “Lahore” are ranked subsequently, each with 2 appearances. (Again, for simplicity, additional words in the snapshot are not depicted. In an actual situation, all words would be counted and ranked.)

TABLE 4

| filtered snapshot word list | Appearances |
|---|---|
| Obama | 4 |
| Tiger | 3 |
| Healthcare | 2 |
| Baghdad | 2 |
| Lahore | 2 |
| etc. | |

Once the ranking module has ranked the words of the filtered snapshot word list in descending order of appearance frequency, an initial topic grouping module of the ranking system may use each word as a topic inclusion criterion; that is, the grouping module may identify those content items (or item samples) in the snapshot that contain the ranked word for each word in the ranked and filtered snapshot word list. Each word thus becomes a keyword for defining a topic grouping or a topic inclusion criterion. Once identified, each such content item may be associated with one or more keywords, in addition to the ranking of such content item as retrieved from the content source and stored in the content snapshot table. Content items may be listed within a table created by the initial story module more than once, corresponding to each parsed keyword of the headline (or text sample). At this point, it can be seen that the individual keywords in a snapshot word list have provided a set of initial topic inclusion criteria that brings together the content items of a snapshot that share a keyword in their respective headlines.

As depicted below in Table 5, one or more content items from a snapshot, each represented by its headline, is depicted as associated with a parsed and filtered word from the headline from such content item. The first filtered snapshot word and first topic inclusion criterion listed in the table is “Obama,” and the content item headlines associated with the word “Obama” (i.e., containing the word “Obama”) include “Obama Healthcare,” “Obama Bill Trouble,” “Obama Health Bill,” “Obama vs. Insurers.” Each content item headline has associated with it its ranking in the ranked listing in which it was found; the rank is associated with the headline in Table 5 by placing it in parentheses after the headline, e.g., the “Obama Healthcare” content item was ranked first in its ranked listing, “Obama Health Bill” was ranked second in its ranked listing. The headlines of content items containing other words in the filtered snapshot word list are similarly associated, as depicted in Table 5. As can be seen, the content item (article or story) “Tiger Woods in Crash” is associated with three keywords from the filtered snapshot word list, “Tiger,” “Woods,” and “Crash,” the word “in” having been filtered out.

TABLE 5

| | Topic keywords for initial |
|---|---|
| Content Items - (Rank) | topic grouping sets |
| Obama Healthcare (1) | Obama |
| Obama Bill Trouble (1) | |
| Obama Health Bill (2) | |
| Obama vs. Insurers (3) | |
| Obama Healthcare (1) | Healthcare |
| Washington Healthcare Jam (1) | |
| Tiger Woods in Crash (2) | Tiger |
| Tiger Gets Bruises (3) | |
| Tiger Out for Week (3) | |
| Tiger Woods in Crash (2) | Woods |
| Tiger Woods in Crash (2) | Crash |
| Bomb in Baghdad (3) | Bomb |
| Bomb in Baghdad (3) | Baghdad |
| Riot in Lahore (2) | Lahore |
| Unrest in Lahore (1) | |

The analysis represented in Table 5 presents the opportunity for using the keywords to select initial topic grouping sets, i.e., each set is a collection of content items with a common topic that should be ranked together. This can be done by various means of logically combining the initial topic inclusion criteria. One method is to have a topic grouping module identify groupings that have a content item in common and then make a new topic definition that assembles all content items that have either of the two keywords that appear in the text sample (here, headline) of the content item that is in common. This logic leads to using the appearance of either the keywords Obama or Healthcare to define a new, joined grouping (or set) of content items. In such a grouping under the initial topic inclusion criteria, a content item duplicated is included only once in the joined grouping, so that it is not over-weighted in the scoring discussed below. As will be seen, if after two keywords are joined to form an “or” logic topic inclusion criterion, a content item still is listed in another content grouping set, the keyword for a third content grouping set may become another part of the “or” logic for a new topic inclusion criterion. In this way, the content items can be grouped according to a set of common keywords.

In some embodiments, the content ranking system disclosed herein may allow a user to edit and/or combine the content items which are associated with a particular keyword of the filtered snapshot word list. A topic grouping module of the ranking system may be configured to supplement each initial topic grouping (as processed by the initial topic grouping module) with any content items in another initial topic grouping that are identified as having content overlap with the initial topic grouping. In this manner, in addition to single words parsed from content item headlines, association of content items may be based on combinations of words which may have content topic overlap. For example, referring to FIG. 3, the combination of “Word321” or “Word322” may be selected by a user to associate content items. Thus, content item headlines with both “Word321” or “Word322” in the headline would be associated with that topic grouping. Alternatively, an initial topic grouping based on a single keyword, may be segmented, if it appears to encompass content items from more than one topic, by requiring the presence of two keywords as the topic grouping criterion. Thus, only content item headlines with “Word321” and “Word322” in the headline become part of one content grouping. The content items having only Word321 or Word322 do not become part of the Word321 and Word322 topic grouping. Once that separation is done, it may appear that the best topic grouping is defined by a more complex inclusion criteria {Word321 or {Word321 and Word322}}. To aid a user in building grouping inclusion criteria, a topic grouping module can be programmed to suggest topic inclusion criteria that eliminate or substantially eliminate the inclusion of content items in multiple topic groupings.

The topic grouping module may present the initial topics as provided by the initial topic grouping module to a user through an electronic interface, for example, an electronic display device associated with a computer or computing system. The user may receive from the initial topic grouping module a listing, as discussed above, of initial topics based on single keywords parsed from the received content. In this manner, through the interface, the user is able to quickly view the initial topics presented, and based on the user's experience, judgment, or other criteria, select additional words for inclusion in or exclusion from a given content topic set. The interface may allow the user to interact with the system to prepare or modify a topic listing through one or more data entry fields, or other data entry or indication means.

Thus, the topic grouping module allows the development of topic inclusion criteria consisting of several keywords logically combined using any known Boolean operators (or other logical operator), for example “and,” “or,” “not,” among others, in any combination. For example, an association based on {“Word321” and “Word322”} or {“Word323” not “Word324”} may be specified, and made part of the logic for a final topic grouping. Such combinations of words may be specified by a user, or they may be determined automatically by the system from user-specified rules, e.g., such as a content item overlap rule applied above or one or more rules derived by neural networks after a period of user selection. Automatic word logical combination determinations may be accomplished by known statistical methods, such as regression analysis, where headline word combinations having greater than a specified statistical correlation (R-squared value, for example) may be joined for a topical grouping set.

As depicted in Table 6 below, parsed keywords of the filtered snapshot word list of Table 5 have been associated with the “or” Boolean operator according to content relatedness. For example, individual words “Obama” and “healthcare” have been associated to form a topic inclusion criteria entry of {Obama or healthcare}. Similarly, individual words “Tiger” and “Woods” have been associated to form an entry of {Tiger or Woods} and “Bomb” and “Baghdad” are similarly joined to eliminate the appearance of a content item in more than one initial topic grouping as in Table 5. Depicted next to each word or combination of words forming inclusion criteria for initial topic grouping sets are the associated headlines of the content items from which such word or combination of words are derived, as discussed above with regard to Table 5.

TABLE 6

| | Topic keywords (inclusion criteria) for |
|---|---|
| Content Items - (Rank) | final topic grouping sets |
| Obama Healthcare (1) | Obama OR Healthcare |
| Obama Bill Trouble (1) | |
| Obama Health Bill (2) | |
| Obama vs. Insurers (3) | |
| Washington Healthcare Jam (1) | |
| Tiger Woods in Crash (2) | Tiger OR Woods |
| Tiger Gets Bruises (3) | |
| Tiger Out for Week (3) | |
| Bomb in Baghdad (3) | Bomb AND Baghdad |
| Riot in Lahore (2) | Lahore |
| Unrest in Lahore (1) | |

It will be seen that the inclusion criteria for one snapshot are saved because they should generally be re-used for the next and at least several succeeding snapshots. Reusing the inclusion criteria helps make the topic grouping sets of one snapshot comparable to the next.

### Scoring for Index

As previously discussed, the ordinal ranking of each content item within its ranked listing from a content source (e.g., RSS feed) may be accessed, retrieved, and stored by the system within one or more databases and associated with its respective content item in the content/snapshot table. Based on this ranking, a story ranking module of the content ranking system disclosed herein may compute a topic ranking content performance index score for each final topic grouping set (for example, as depicted in Table 6) by assigning to each content item in each final topic grouping an individual rank score that represents the content item's original ranking in the ranking list in which it appears. This individual rank score may be computed based on the ordinal list ranking, using a variety of scoring schemas that translate an ordinal ranking into a score, for example, schemas that are linear, nonlinear, logarithmic, exponential, among others. Each individual rank score of the content items in a final topic grouping then contributes to a content performance index score for the content items in that topic grouping set. A topic scoring module may be used to compute the score for each topic grouping set.

A scoring schema may be embodied in a table that may be used by an topic ranking module. Simplified examples of scoring 4-level schemas that might be available to a topic ranking module are depicted below in Table 7. In this simplified table, ordinal ranks 1 through 4 are depicted with an associated linear, nonlinear, logarithmic, and exponential score. In one embodiment, the system 225 stores a library of scoring schemas. These can then be selected by users or selected automatically for different index scoring tasks. For example, a general news topic ranking index might provide more useful results with a linear scoring schema, while a sports or other more limited topic ranking might perform better with another scoring schema.

TABLE 7

| Ordinal | | | | |
|---|---|---|---|---|
| Rank | Score Linear | Score Nonlinear | Score Log. | Score Expon. |
| 1 | 4 | 10 | 0 | 1 |
| 2 | 3 | 7 | .301 | 4 |
| 3 | 2 | 3 | .477 | 9 |
| 4 | 1 | 1 | .602 | 16 |

In one embodiment, the scoring schema is a linear schema that simply inverts a 1-to-10 ranking list. Thus, content items ranked no. 1 are scored with 10 points, content items ranked no. 2 are scored with 9 points, and so on until content items ranked 10 are scored with one point. This can be defined either in a table or algorithm formula as: Score Linear=11−ordinal rank. Other scoring schemas can similarly be specified for computation.

Applying a selected scoring schema, a content index ranking module of the content ranking system disclosed herein may form a topic index ranked list by computing an aggregate index score from the individual rank scores for each content item in each final topic grouping, thereby making a ranked list by aggregate index score for each final topic grouping in a snapshot. As depicted in Table 8 below, for example, using the simplified, 4-level linear scoring model from Table 7 above, the “Obama healthcare” headlined content item, with associated ordinal ranking of 1, would be scored a 4, and this score would be associated into the aggregate index score for the final topic grouping “Obama or healthcare” in Table 6, Similarly, the “Obama Bill Trouble” headlined content item, with associated ordinal ranking of 1, would be scored a 4, and this score would be associated also into the aggregate index grouping score for the final topic grouping “Obama or healthcare” in Table 6. Summing up all such scores for all ranked content items associated with “Obama or healthcare,” the aggregate index score final topic grouping score for “Obama or healthcare” is 4+4+3+2+4, or 17. Similar index scores may be thusly computed for each final topic grouping as determined by the final topic grouping module discussed above.

TABLE 8

| | filtered | |
|---|---|---|
| | snapshot | |
| | word list - | |
| Content items | criteria | Index Score for |
| by story (rank | for final topic | Final topic grouping |
| in its list) | grouping | (4-3-2-1 schema) |
| Obama Healthcare (1) | Obama OR | 4 + 4 + 3 + 2 + 4 = 17 |
| Obama Bill Trouble (1) | Healthcare | |
| Obama Health Bill (2) | | |
| Obama vs. Insurers (3) | | |
| Washington Healthcare Jam (1) | | |
| Tiger Woods in Crash (2) | Tiger OR | 3 + 2 + 2 = 7 |
| Tiger Gets Bruises (3) | Woods | |
| Tiger Out for Week (3) | | |
| Bomb in Baghdad (3) | Bomb AND | 2 + 3 = 5 |
| Baghdad Struck Again (2) | Baghdad | |
| Riot in Lahore (2) | Lahore | 3 + 4 = 7 |
| Unrest in Lahore (1) | | |

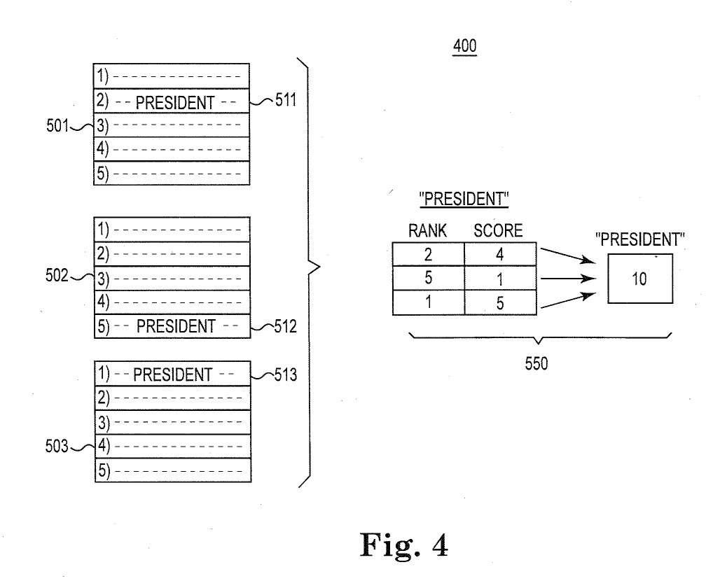

An example content index ranking module 400 is schematically shown in FIG. 4 to further illustrate the scoring and ranking process as implemented by the content ranking system of the present disclosure. In the example of FIG. 4, the key word “President” is used as a topic inclusion criterion and appears in the headline of a content item in three separate, 5-level ranked listings from the feeds of three separate websites (content sources) 501, 502, and 503. In the ranked listing of website 501, the word “President” appears in the second ranked content item (511), in the ranked listing of website 502, the word “President” appears in the fifth ranked content item (512), in the ranking of website 502, the word “President” appears in the first ranked content item (513). Using a linear scoring model for a ranked listing of 1-to-5, for example, the second ranking in listing 501 corresponds to a score of 4, the fifth ranking in listing 502 corresponds to a score of 1, and the first ranking in listing 503 corresponds to a score of 5. Therefore, using the mathematical operation of addition, for example, the combined index score for the topic defined by the word “President” over the three ranked listings 501, 502, 503 accessed and retrieved is 10 (shown at step 550). Like index scorings may be provided for any number of ranked listings having any number of content items in accordance with the present disclosure.

Other examples using other scoring schema and index score computation models are also within the scope of the present disclosure, as will be appreciated by those skilled in the art. For example, the score associated with an ordinal ranking may be weighted as part of an aggregating computation to compute index scores. If a particular ranked listing or content source is seen as having a larger audience or a more desirable demographic driving its rankings, then the scores associated with the ordinal ranking in that ranked listing may be multiplied by a weighting factor. For example, using weighting factors 1.5 or 2.0, content item no. 1 in a Google ranked listing of a top ten, instead of having a score of 10, may have an index score contribution to its topic grouping set of 1.5×10=15, or 2×10=20, with content item no. 3 on the same Google listing, normally contributing to its topic grouping set a score of 8, using the same weighting approach, contributing to its topic grouping set a 1.5×8=12 or 2×8=16 to an index score computation. Thus, the Google ranking for a content item of no. 1 or no. 3 would contribute more to an index score than a no. 1 or no. 3 content item in the same topic grouping set but from another ranked listing, such as Yahoo. Correspondingly, a particular content source might be down-weighted, if relative to other content sources aggregated in a content performance index it is viewed as having less desirable demographics.

### Logical Flow

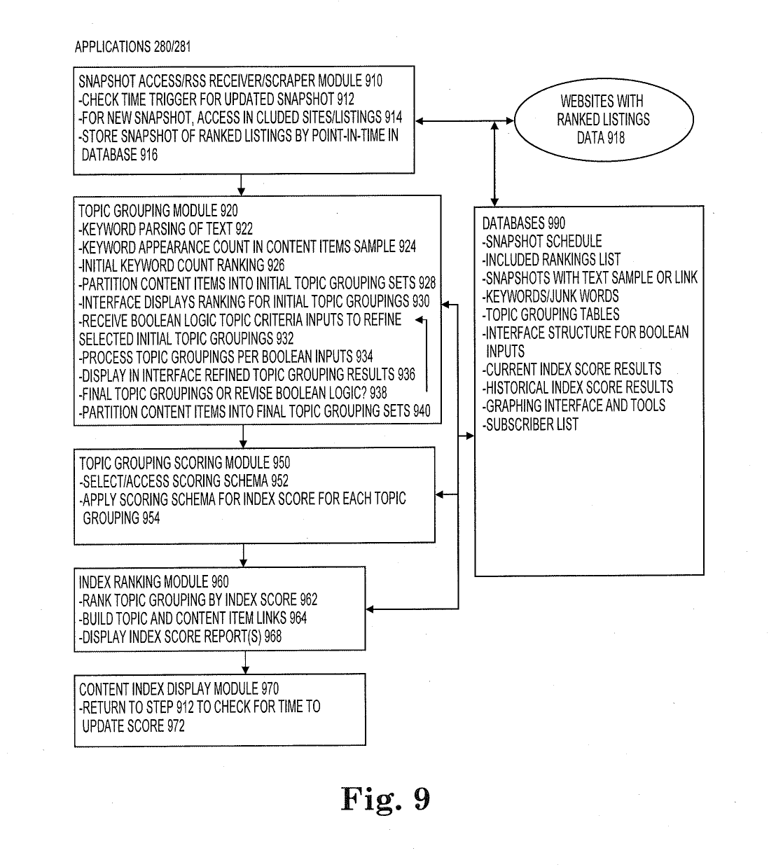

FIG. 9 shows a functional block diagram that summarizes one embodiment of the method and system described above. The processing logic discussed above may be implemented in application software 280 or 281 as referenced in FIG. 1. While the actual implementation may be in the form of many software objects, for simplicity FIG. 9 shows: Snapshot Access/RSS Receiver/Scraper Module 910, Topic Grouping Module 920, Topic Grouping Scoring Module 950, Index Score Ranking Module 960, Content Index Display Module 970, and certain functions performed by each of these modules. FIG. 9 also shows Database 990 with which these modules interact.

Processing of a content index score report for the set of ranked listings that are to be aggregated may begin with checking whether it is time for an updated snapshot 912. If it is time for new snapshot and updated content index scores, the system may access the sites/listings 914 to be included in developing an aggregated ranking. The ranked listing data 918 gathered by accessing the ranked listings may be assembled as a snapshot associated with a particular point-in-time and stored 916 in Database 990. As noted, below, the index scores can be developed for general national news content or for specialized topic areas, e.g., sports, state, or city news. Thus, different indices may access different ranked listings for aggregation.

With data for the ranked listings (in the form of Table 1 above) stored, the Topic Grouping Module 920 can begin the process of defining the topics addressed by the content items included in the ranked listings gathered at a point in time as one snapshot. The content items forming each topic grouping set become a unit for purposes of computing an index score. A first step in determining the topic of each content item may include keyword parsing of the headline, opening paragraph, or other text sample from a content item 922. Keywords may be found, and junk words eliminated by filtering (Table 2 above). Once that is done for all content items in a snapshot, a keyword appearance count in content items samples may be made 924 (see Table 3 above). The filtered keywords may then be ranked by number of appearances 926. This ranking of keywords by number of appearances (see Table 4 above) may provide an initial rough ranking of topics, with the each keyword serving as a rough proxy for a content topic. That is, the frequent appearance of “Obama” in many content items suggests that one or more topics in which President Obama is involved are among the popular content. By contrast, the less frequent appearance in this snapshot of the name of a low-profile U.S. senator, would suggest that content items involving that senator are less popular content.

The initial keyword count ranking as in Table 4 may act as a partitioning of content items based on the presence of particular keywords 928. This partitioning can be expanded to display in an operator interface the content item set associated with each keyword 930, which form the initial topic grouping sets (Table 5). An operator can then review the keywords and content items that contain that keyword and refine the topic groupings. Some groupings may not require any refinement. If needed, refinement may be done by the operator determining whether an initial topic grouping set is improved by supplementing, i.e., by joinder with another selected initial topic grouping set. This joinder can occur by the operator interface receiving input 932 of a Boolean logic OR command to join the selected sets associated with either of two initial keywords. (If necessary, duplicate items may be removed from the joined set.) In some circumstances, an initial topic grouping set may be viewed as covering multiple topics. A refined, smaller subset can be defined by the operator interface receiving a Boolean logic AND command to make a topic grouping set of content items containing each of two keywords. As noted above, more complex Boolean logic inputs received at the interface can produce additional refined topic grouping sets. Processing the keyword-focused grouping sets based on the Boolean inputs 934, the module 920 can create a new display at the operator interface with the refined topic grouping sets, showing the Boolean criteria for keywords that produces the refined topic grouping sets 936 (see Table 6). The operator interface may accept new or revised Boolean inputs as needed to structure criteria for topic grouping sets around keywords, until the operator inputs a signal that final topic groupings have been defined 938. (The arrow linking steps 938 and 932 indicates that this refining process may be iterative.) The module 920 may complete whatever duplicate removal may still be needed, which partitions content items into final topic grouping sets 940.

Once the final topic grouping sets are defined, a Topic Grouping Scoring Module 950 may be used to compute the score for each final topic grouping defined by a Boolean criterion. The Topic Grouping Scoring Module 950 may access a pre-selected scoring schema, unless the operator interface calls for selection of the scoring schema 952. As discussed above, the schema may be various (see Table 7) and may include weighting. The module 960 may apply a scoring schema to compute an index score for each topic grouping 954 (see Table 8).

Using the computed scores, the Index Ranking Module 960 may rank each topic grouping by its index score 962. The module 960 can build and display reports with links 964 that permit content item included in a topic grouping to be identified by ranking source or accessed, or may annotate index score rankings with trends (color codes for rise or fall in rankings). Rankings may be identified by snapshot date and time. Once a ranking report has been developed from a snapshot, a new report may not be developed until a timing signal indicates that it is time to the index scores. Thus, control at 972 may return to step 912, at which the module 910 may check for the time trigger for the next snapshot and corresponding index scoring process. Once a report is complete, it may be released to the subscribers for that particular report.

The processing of the modules is supported by data in the database 990, which may include: snapshot timing schedule—defines when snapshots are to be taken, which may vary by index; included rankings list—identifies the web sources for the rankings listings that are to be aggregated for a particular index (may contain URLs, RSS data, or other access instructions); stored snapshots with text sample or link—raw data captured on ranked listings at various points in time; keywords/junk words list—identifies words that may be found in parsing but are to be discarded as not useful for topic grouping; topic grouping tables—various tables built in the course of defining and refining the Boolean keyword criteria for topic grouping sets; interface structure for Boolean inputs—specifies the screens of the operator interface for displaying initial and refined groupings and accepting the Boolean AND, OR, NOT, etc. operators for combinations of keywords; current index score results—shows the most recent snapshots index scores, for one or more aggregation fields; historical index score results—archive of past snapshots index scores for use in graphing; graphing interface and tools—used for showing historical or comparative trends; subscriber list—identification or persons permitted to access index score reports.

### System Configuration and Display

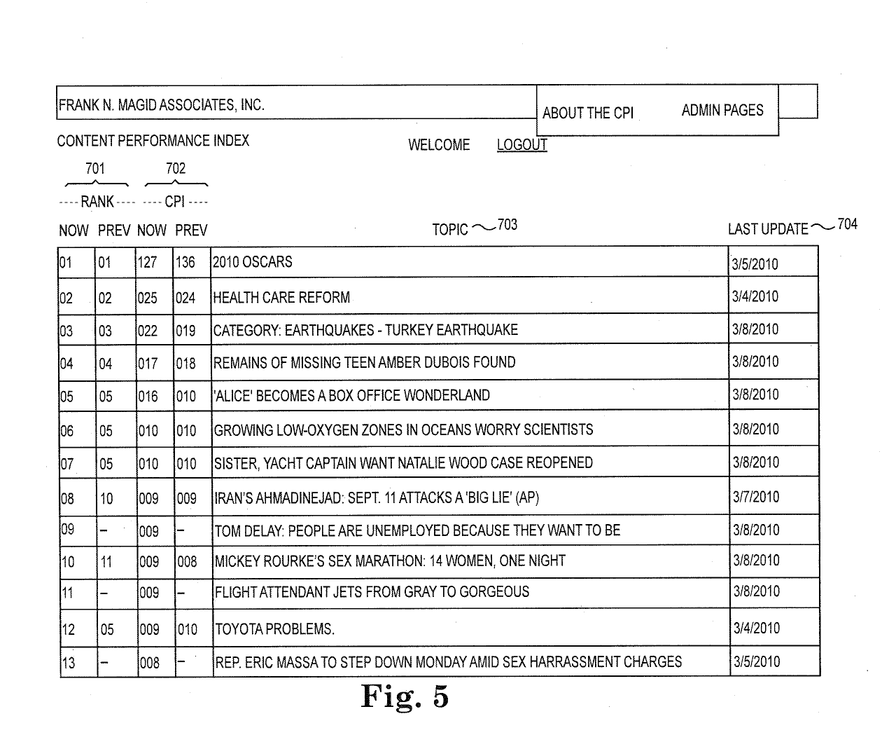

As previously discussed, the system in accordance with the present disclosure may be accessed by and/or displayed to an authorized user on any suitable electronic terminal device, for example, a personal computer. FIG. 5 depicts an example computer display of a combined/aggregated index score ranked listing prepared by a system and method in accordance with the present disclosure from a current and a previous snapshot of several ranked listings. Topic field 703 displays to the user words descriptive of the topic associated with a particular topic inclusion criterion, i.e., a headline keyword or logical combination of headline keywords used as final topic grouping criteria. The topic description may actually be the set of keywords used as the final topic grouping criteria or it may be a headline from one of the content items in the final topic grouping. For example, the first listed topic in Topic field 703 in FIG. 5 reads “2010 Oscars.” In this example, the topic “2010 Oscars” may correspond to a final topic grouping criteria selecting content items in the ranked listings that have the keywords “Oscars” or “Oscar”. The topic “2010 Oscars” is depicted as first in Rank field 701, both in the current snapshot ranking and the previous snapshot ranking (columns labeled “Now” and “Prey”, respectively). As discussed previously, ranking snapshots may be taken automatically every hour, day, week, etc. A “Content Performance Index,” (“CPI”) or aggregated ranking index score (in CPI field 702) as previously discussed, is depicted adjacent to the Rank field 701. As with the Rank field 701, the CPI field 702 shows an index score for both the current snapshot and the previous snapshot. As depicted, the aggregated ranking index score (developed in a process as shown in the example of Table 8) for the topic “2010 Oscars” has decreased 9 points between snapshots from 136 to 127, although this topic remained in first rank above the next highest scoring topic, “Health Care Reform,” (corresponding to a criteria for final topic grouping based on both keywords “Health” and “Care” being in the content item headline) by a wide margin. Such aggregated ranking or performance index scores therefore depict the relative importance or interest of a particular topic set forth in Topic field 703. In this example, therefore, 2010 Oscars (“Oscar” or “Oscars” in the content item headline) was approximately five times more interesting to the viewers of the websites accessed for the “now” snapshot than Health Care Reform (“Health” and “Care” in the content item headline).

In some embodiments, the content of the Topic field 703 is created for ease of reference by an Administrator or Operator of the system 225 who reviews the various keywords and headlines and perhaps the content items themselves for a final topic grouping set. Alternatively, the content of the Topic field 703 may be created automatically by the system 225 based on the keyword or keyword combination defining each final topic grouping scored and ranked. Furthermore, in some embodiments, the Administrator or Operator of the system 225 may manually add or delete content items from a particular final topic grouping, where the display of headlines (or review of the content item) for a final topic grouping makes it clear that a content item should not be included in the grouping. For example, if a content item with the headline “Stories of Oscar Wilde” was included within the Topic “2010 Oscars” (based on a keyword “Oscar”), the Administrator or Operator would be able to delete such article from the topic as non-related. If this is done after scoring each final topic grouping, the deletion would cause the score for this final topic grouping to be recalculated, thereby automatically changing the associated combined score in CPI field 702 and possibly ranking in Rank field 701). Alternatively, if a content item with the title “Hollywood Stars on the Red Carpet” appears in a ranked listing and is identified as pertinent to the Topic “2010 Oscars”, the system Administrator or Operator may add such article item to the final topic grouping, even though it was not identified by the topic inclusion criteria for the grouping “2010 Oscars” as containing the word “Oscar” or “Oscars.” A “Last Update” category, as shown in FIG. 5, indicates when the word or word combination serving as the topic inclusion criteria to a particular Topic 703 was most recently updated. As noted, once a topic inclusion criteria is useful, that utility for index computation may persist for several days or weeks as a topic continues to develop and/or receive coverage.

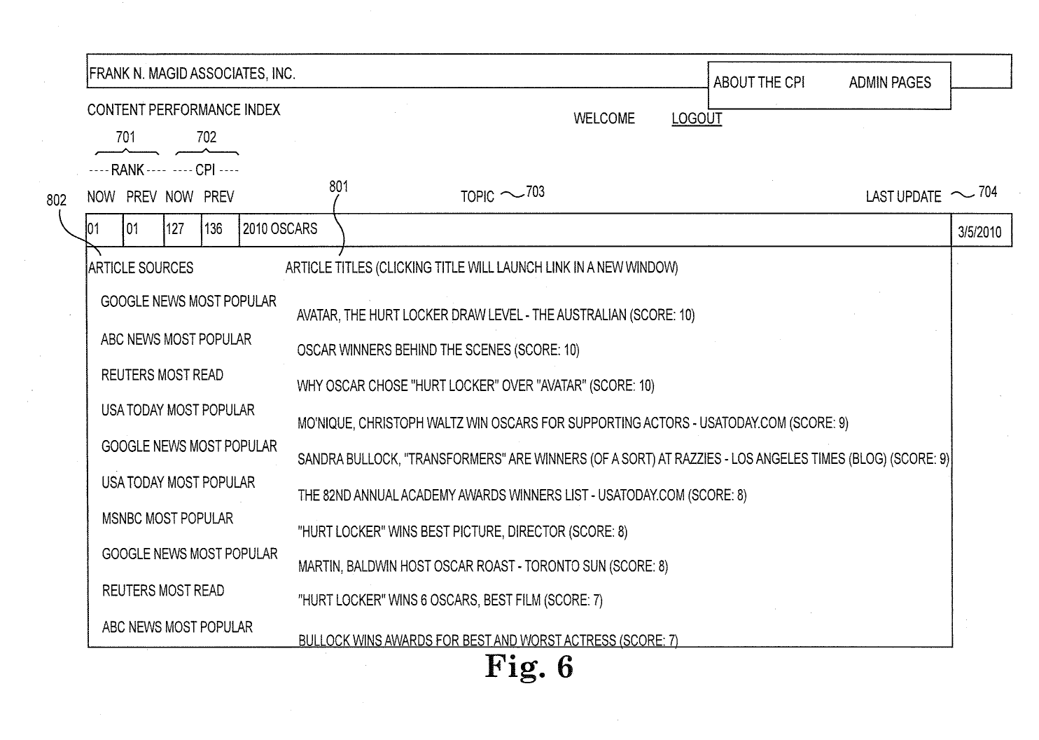

Clicking, or otherwise selecting a particular topic in Topic field 703 results in a list below each topic that provides the user with additional information on the content items grouped for that topic. As depicted in FIG. 6, below the topic “2010 Oscars” may be provided a listing of all content items which contributed to the “2010 Oscars” index score and ranking (i.e., all content items accessed and retrieved from website ranked listings that have the words “Oscar” or “Oscars”). The “Articles Titles” field 801 displays the title of each individual content item included in the final topic grouping, along with its associated individual score (based on its ranking in its own ranked listing). The “Article Sources” field 802 displays the website ranked listing from which each corresponding content item was (or may be) accessed/retrieved. In some embodiments, the “Article Titles” 801 may be internet hyperlinks to the particular content item, such that a user may directly link to the content item by a web browser, or other similar means. Further, the “Article Sources” field 802 may contain internet hyperlinks to the website containing the particular ranked list where the content item is ranked.

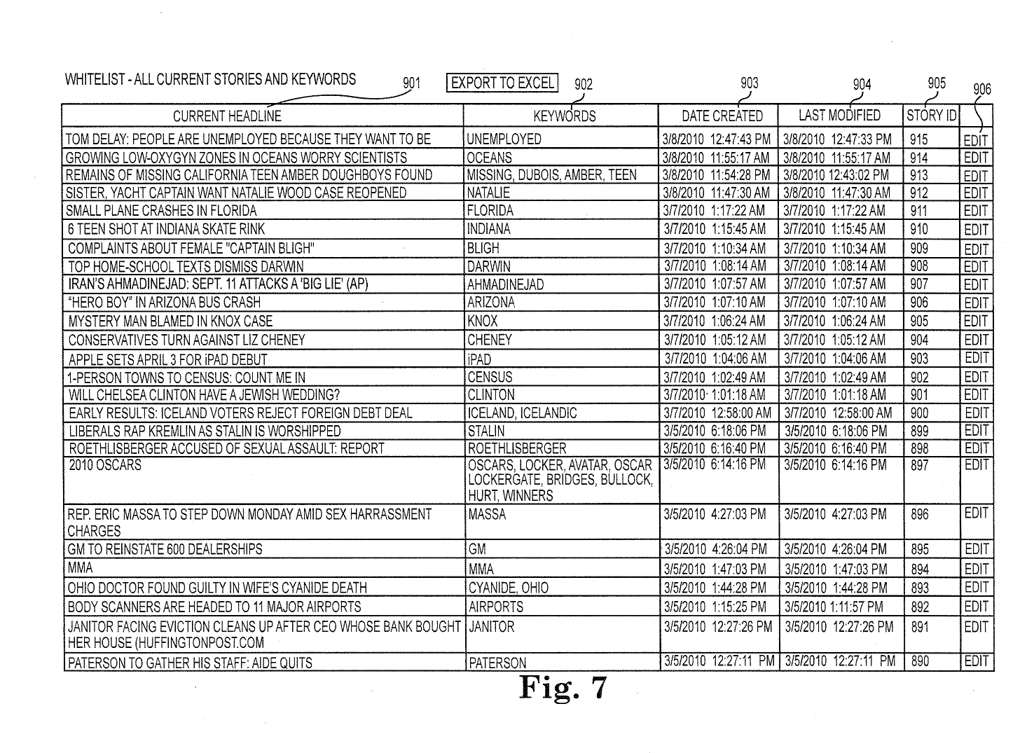

FIG. 7 depicts an example editing interface display for the current content items/final topic groupings in the system, as described above. With such a listing, a system Administrator or Operator may be able to monitor the functioning of the system, and make any of the topic selections, changes, or modifications as have been discussed in greater detail above. In the Example display shown, various content item headlines, identified in “Current Headline” field 901 are shown with their corresponding parsed headline words forming topic inclusion criteria in “Keywords” field 902. In this manner, the Administrator or Operator may monitor and guide the functioning of the system for topic relevance, provide to the interface Boolean grouping inputs, and delete or add content items as appropriate, using the operator's judgment and experience. Additional information may also be provided, including a date in a “Date Created” field 903 and a “Date Modified” field 904, and a unique content item identifier in Story ID field 905. Editing or configuring of the various aspects of the presently described system, including Topics, words or word combinations, among other aspects, may be accomplished through selecting that action an associated “Edit” column 906. This display interface allows and Operator to quickly, easily, and efficiently select final topic groupings for the system, and monitor the continued relevance of existing topic groupings. By centralizing this functionality into a single display interface, the presently disclosed system makes it easy for an Operator to perform the designated functions, provides the Boolean grouping inputs, and ensures that the Operator has to most up-to-date information to make decisions concerning topics and content.

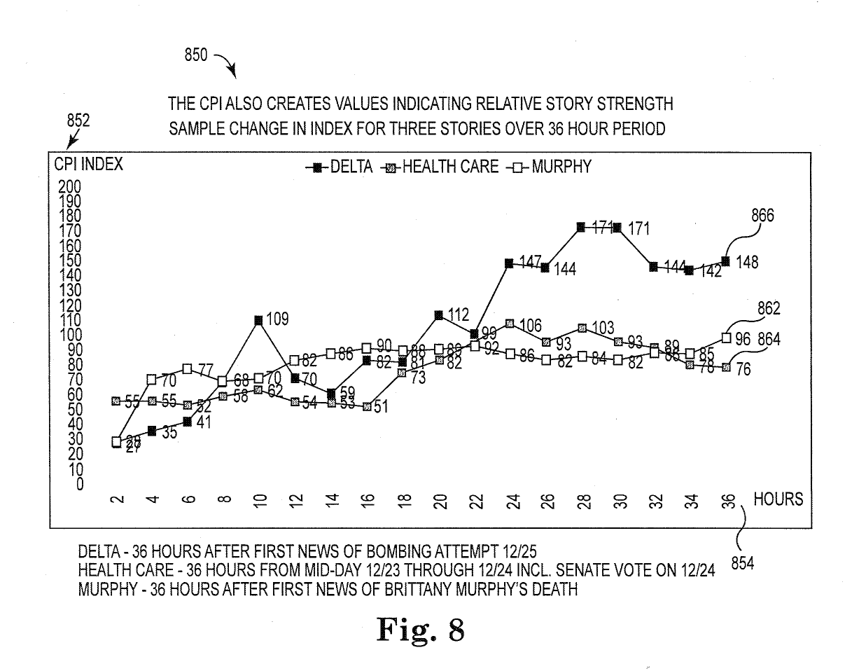

One result from taking snapshots at periodic intervals is that the changes in index scores can be tracked. This is particularly useful when the index value of multiple topics can be tracked over time, to see how the topics increase or decrease in ranking. FIG. 8 shows a screenshot example of a graph 850 of content performance index scores, as reflected in the vertical scale 852, for three topics/stories in a sequence of snapshots taken over thirty-six hours, as reflected in the horizontal scale 854. In this graph, only three topics (or stories) from a larger group of topics or stories in found in a snapshot are tracked, in three traces 860, 862, 864. The shorthand topic labels Delta, Health Care and Murphy are explained further in the notes below the horizontal axis. Such a display is useful to show the interest performance of the content items on each of these topics over the thirty-six hours for which ranked listing are gathered in snapshots and the index scores derived from the ranked listings data. This provides quantitative data, with an understandable basis, to aid management judgment or to directly drive automated content display functions. The system presents such graphs by allowing the user to select data sets stored in the databases discussed above and feed these data to standard graphing software applications, such as those in Microsoft Excel.

In some embodiments, access to certain features of the presently described system may be limited or otherwise restricted. While the system is flexible in various ways in defining the final topic groupings that are to be ranked, some of the flexibility may be reserved to administrators. For example, it may be desirable to limit certain users, for example commercial subscribers to the system, to viewing the rankings/index scores and the content items and sources associated with each (for example, the display screens of shown at FIGS. 5 and 6). These viewers may not be able to access the editing or configuring functions, such as adding/removing content items to/from a topic, creating a new topic, creating a new Boolean word combination (for defining the topic inclusion criteria for a final topic grouping, changing the snapshot interval, selecting score weighting, among others. Such functions may be limited to the Operators or Administrators of the system. Alternatively, all categories of users may have access to all functions of the system. User access may be delimited by a standard UserName/Password login screen, with each user having a separate account with a corresponding access level, as will be known to and appreciated by those skilled in the art.

While the examples above have been described generally with reference to news content, it will be appreciated that the presently disclosed system can also be used in connection with other types of ranked content, such as content that may be of special interest to specially defined audiences. Such specialized content may be based around particular keywords specific to such specialized content, and such specialized content may be particularly found in publications directed to such specifically defined audiences. These specialized topics may include, for example, health, politics, entertainment, South Florida, Northwest, Northern California, and Twitter®, among various others. Boolean logic can be used to focus content groupings on specialized topics of interest. In the example of a “South Florida” specialized topic, the Boolean operator AND may be used in connection with other content keywords to focus the content groupings on the specialized topic, e.g., {“South Florida” AND “art gallery”} for a content pertaining to art galleries within the specialized topic of South Florida.

Although the present disclosure has been described with reference to various embodiments, persons skilled in the art will recognize that changes may be made in form and detail without departing from the spirit and scope of the disclosure.

What is claimed is:

1. A computer implemented system for processing data representing ranked listings of content items, comprising:
a computer processor configured to receive a snapshot associated with a point in time of data representing a ranked listing from each of two or more content sources, each listing ranking a plurality of content items;
a database operably connected to the processor and configured to store for each ranked listing from each content source in a snapshot at least a text sample and the ordinal ranking of each content item in its ranked listing;
a software-implemented topic grouping module configured to parse the text samples in a snapshot into keywords and responsive to keywords that the content items in a snapshot have in common, partitioning the content items in a snapshot into a plurality of topic grouping sets;
a software-implemented topic scoring module configured to compute an index score for each topic grouping set from a snapshot by assigning to each content item in each topic grouping an individual rank score that represents that content item's ordinal ranking in the ranked listing in which it appears in the snapshot and, responsive to the individual rank scores, computing an aggregate topic grouping score for each topic grouping set from the individual rank scores for each content item in each topic grouping derived from a snapshot;
a software-implemented content index ranking module configured to form an index ranked list by forming a ranked listing by aggregate topic grouping score for each topic grouping set in a snapshot; and
a display device operably connected to the processor and configured to display the index ranked list.

2. The system of claim 1, wherein the software-implemented topic grouping module comprises:
a software-implemented parsing module configured to parse a text sample of each content item into individual words, to form a snapshot word list and to filter junk words from the snapshot word list to produce a filtered snapshot keyword list containing all content text sample words in a snapshot;
a software-implemented counting module configured to compute an appearance frequency for each keyword in the filtered snapshot keyword list for all text samples of content items included in the snapshot;
a software-implemented keyword ranking module configured to form a ranked list by appearance frequency of each keyword in the filtered snapshot keyword list;
a software-implemented initial topic module configured, for each keyword in the ranked filtered snapshot keyword list, to identify the content items in the snapshot containing that keyword and the associated rank of each such content item in the ranked listing in which it appears in the snapshot, said set of content items containing a common keyword in the filtered word list comprising an initial topic grouping set associated with that common keyword; and
a software-implemented final topic module configured to receive a Boolean input that refines initial topic grouping sets by specified logical operations with content items in at least one other initial topic grouping set identified as having content overlapping with or distinct from the initial topic grouping set to form a final topic grouping set.

3. The system of claim 1, wherein the computer processor is configured to access content from a website.

4. The system of claim 3, wherein the computer processor is configured to access an RSS feed from the website.

5. The system of claim 1, wherein the database is configured to store one or more of a unique identifier, a URL, a date and time, a rank, and text, associated with a content item.

6. The system of claim 2, wherein the parsing module is further configured with a list of junk words which are excluded from the filtered snapshot keyword list.

7. The system of claim 1, wherein the topic scoring module comprises at least one scoring schema for associating a ranking in a ranked listing with a score.

8. The system of claim 7, wherein the scoring schema is linear.

9. The system of claim 1, wherein the text sample is selected from the group comprising a content item headline, an initial sentence of a content item, an initial paragraph of a content item and the full text of a content item.

10. The system of claim 1, wherein the index ranked list displayed is a table with one row for each final topic grouping.

11. The system of claim 1, wherein the index ranked list displayed identifies a final topic grouping set by an associated content headline.

12. The system of claim 11, wherein the associated content headline provides an electronic link to the content item.

13. The system of claim 1, wherein the display device is configured to display ranking information from both a current snapshot and a previous snapshot.

14. The system of claim 1, wherein a final topic grouping set is defined by two or more words with a specified Boolean operator joining them.

15. The system of claim 1, wherein the two or more content sources are selected automatically by the system for a snapshot.

16. The system of claim 1, wherein the system is configured to receive a sequence of snapshots of data at regular intervals of time.

17. The system of claim 2, wherein the topic grouping module is further configured to allow a user to manually add or delete content items from a initial topic grouping set.

18. The system of claim 1, wherein the system further comprising a software-implemented graphing module configured to display the index score for a topic grouping set over a period of at least twelve hours.

19. In a system for processing data representing ranked listings of content items, a method comprising:
using a computer processor: accessing a snapshot associated with a point in time of data representing a ranked listing from each of two or more content sources, each listing ranking a plurality of content items;
using a database operably connected to the processor: storing for each ranked listing from each content source in a snapshot at least a text sample and the ordinal ranking of each content item in its ranked listing;
using the computer processor and a software-implemented topic grouping module: parsing the text samples in a snapshot into keywords and responsive to keywords that the content items in a snapshot have in common, partitioning the content items in a snapshot into a plurality of topic grouping set;
using the computer processor and: computing an index score for each topic grouping set from a snapshot by assigning to each content item in each topic grouping set an individual rank score that represents that content item's ordinal ranking in the ranked listing in which it appears in the snapshot and, responsive to the individual rank scores, computing an aggregate topic grouping score for each topic grouping set from the individual rank scores for each content item in each topic grouping set derived from a snapshot;
using the computer processor and a software-implemented content index module: forming an index ranked list by forming a ranked listing by aggregate topic grouping score for each topic grouping set in a snapshot; and
using a display device operably connected to the processor, displaying the index ranked list.

20. The system of claim 19, wherein the step of software-implemented topic grouping module comprises:
using the computer processor and a software-implemented parsing module: parsing a text sample of each content item into individual words, to form a snapshot word list and to filter junk words from the snapshot word list to produce a filtered snapshot keyword list containing all content text sample words in a snapshot;
using the computer processor and a software-implemented counting module: computing an appearance frequency for each keyword in the filtered snapshot keyword list for all text samples of content items included in the snapshot;
using the computer processor and a software-implemented keyword ranking module: forming a ranked list by appearance frequency of each keyword in the filtered snapshot keyword list;
using the computer processor and a software-implemented initial topic module: for each keyword in the ranked filtered snapshot keyword list, identifying the content items in the snapshot containing that keyword and the associated rank of each such content item in the ranked listing in which it appears in the snapshot, said set of content items containing a common keyword in the filtered word list comprising an initial topic grouping associated with that common keyword; and
using the computer processor and a software-implemented final topic module receiving a Boolean input that refines initial topic grouping sets by specified logical operations with content items in at least one other initial topic grouping set identified as having content overlapping with or distinct from the initial topic grouping set to form a final topic grouping set.

21. In a computer-implemented system for processing data representing ranked listings of content items, a method comprising:
using a computer processor:
receiving electronic data representing a snapshot of ranked content listings from each of two or more content sources, wherein the snapshot comprises a text sample and the ordinal ranking of each content item in its ranked listing;
parsing the text samples in the snapshots into keywords;
grouping the keywords into a plurality of initial topic groupings, wherein the initial topic grouping include an associated ranking based on the ranking of the content from the keyword originates;
displaying, through an electronic interface, the initial topic groupings to a user, wherein the interface is configured to allow the user to modify the initial topic groupings into final topic groupings by associating or removing one or more additional keywords with such initial topic groupings;
receiving, from the user and through the electronic interface, data representing the final topic groupings;
computing an index score for each final topic grouping; and
forming an index ranked listing by aggregate final topic grouping score for each final topic grouping.

22. The method of claim 21, wherein computing an index score comprises assigning to each content item in each topic grouping set an individual rank score that represents that content item's ordinal ranking in the ranked listing in which it appears in the snapshot.
